(19) United States
(12) Patent Application Publication
(10) Pub. No.: US 2019/0283708 A1
(43) Pub. Date: Sep. 19, 2019

(54) Vehicle Safety System

(71) Applicant: Aaron Arrogante, Selma, TX (US)

(72) Inventor: Aaron Arrogante, Selma, TX (US)

(21) Appl. No.: 16/355,948

(22) Filed: Mar. 18, 2019

Related U.S. Application Data
(60) Provisional application No. 62/644,731, filed on Mar. 19, 2018.

(51) Int. Cl. B60R 25/04; B60R 25/10; B60R 25/102

(52) U.S. Cl. CPC B60R 25/04; B60R 2025/0415; B60R 25/102; B60R 25/1003

(57) ABSTRACT

A vehicle safety system. The vehicle safety system includes a control unit, a mobile device receiver, and a speed sensor. The control unit is operably connected to a vehicle with which the system is to be used. During use of the system, the mobile device receiver registers a mobile device coupled thereto, and the control unit deactivates the vehicle if the mobile device is removed from the mobile device receiver when the vehicle is in motion and may send an alert to an authority if a particular speed is exceeded.

### CROSS REFERENCE TO RELATED APPLICATIONS

This application claims the benefit of U.S. Provisional Application No. 62/644,731 filed on Mar. 19, 2018. The above identified patent application is herein incorporated by reference in its entirety to provide continuity of disclosure.

### BACKGROUND OF THE INVENTION

The present invention relates to vehicle safety. More particularly, the present invention provides a vehicle safety system.

Cell phones are becoming more and more engaging, and many cell phone owners use their cell phones to excess, for example, when driving, and this is extremely dangerous. Cell phone use while driving contributes to an increasing amount of car collisions, accidents, and traffic related deaths. Many states have outlawed the use of a mobile device while driving. However, these laws are not always successful, as they can be difficult to enforce.

Consequently, there is a need in for an improvement in the art of vehicle safety. The present invention substantially diverges in design elements from the known art while at the same time solves a problem caused by unsafe drivers. In this regard the present invention substantially fulfills these unmet needs.

### SUMMARY OF THE INVENTION

The present invention provides a vehicle safety system wherein the same can be utilized for providing convenience for the user when safely driving a vehicle. The vehicle safety system may include a control unit connected to the vehicle. The control unit may have a mobile device receiver and a speed sensor connected to the unit. Further, the control unit is coupled to the ignition system of the vehicle. The mobile device receiver is capable of registering when a mobile device is coupled to the receiver. The controller is configured to shut the vehicle off when the mobile device is removed from the mobile device receiver. This shut off may occur after a predetermined amount of time. Further, the control unit is configured to shut the vehicle off if a predetermined speed is exceeded. In another embodiment the control unit can slow the vehicle down if traveling over a predetermined speed.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of an embodiment of the vehicle safety system.

FIG. 2 shows a perspective view of an embodiment of a mobile device receiver placed in a dash of a vehicle.

FIG. 3 shows a front view of an embodiment of the mobile device receiver unit.

FIG. 4 shows a flow chart of an embodiment of a method of using the safety system to improve the safety of vehicle operation by preventing cell phone usage while driving.

### DETAILED DESCRIPTION OF THE INVENTION

Reference is made herein to the attached drawings. Like reference numerals are used throughout the drawings to depict like or similar elements of the vehicle safety system. For the purposes of presenting a brief and clear description of the present invention, a preferred embodiment will be discussed as used for the vehicle safety system. The figures are intended for representative purposes only and should not be considered to be limiting in any respect.

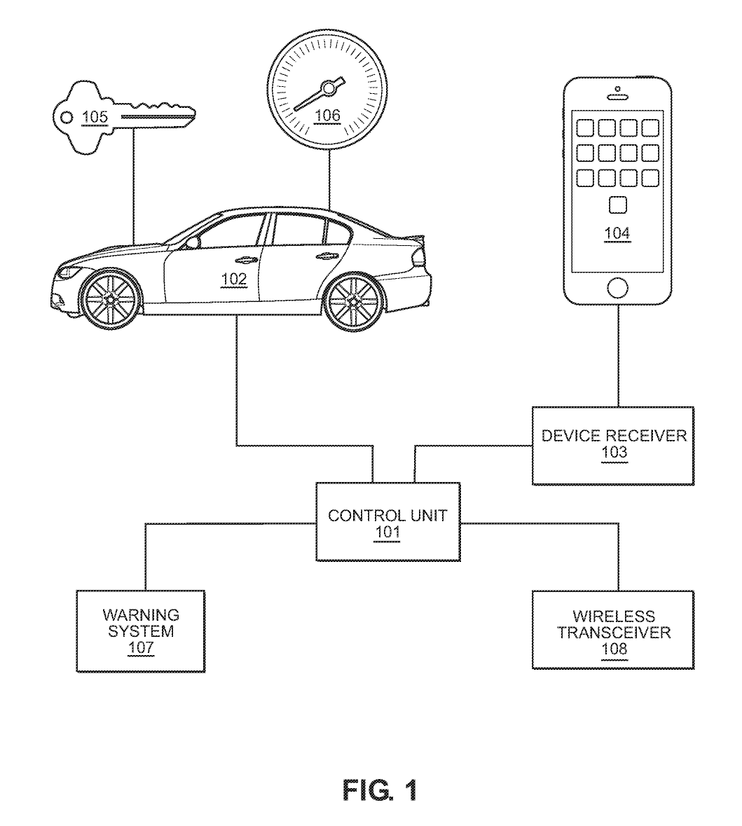

Referring now to FIG. 1, there is shown a diagram of an embodiment of the vehicle safety system. The system includes a control unit 101 operably coupled to a vehicle 102. This connection may be made via the OBD port of the vehicle. The control unit 101 is also coupled to a device receiver 103. The device receiver 103 is capable of registering when the mobile device 104 is coupled to the device receiver 103. The mobile device functions as a key to the vehicle. The mobile device may start the vehicle via an application, which will contain the driver's license information, vehicle make and model, the VIN number, license plate information, and registration information.

The control unit 101 is able to determine a measurement of the vehicle's speedometer 106 via the connection to the vehicle. The control unit 101 may also be coupled to the vehicle's ignition system 105 the ignition system can also include a link to the vehicles computer. The control unit 101 may have the ability to control the vehicle's ignition system 105 via this connection.

The system has a warning system 107 coupled to the control unit 101. This warning system 107 may include a speaker or other audio device. This speaker may be the speaker located in the mobile device itself. In one embodiment the warning system 107 can be incorporated into the mobile device 104 via an application for the mobile device. In one embodiment the warning system 107 is coupled to the vehicles existing audio system. The warning system 107 may further have a timekeeping ability. This can determine if the device has been removed for a length of time.

The control unit 101 is coupled to a wireless transceiver 108. The control unit 101 is capable of sending notification to a registered user device. The registered user may be a parent of a teenager or an insurance company. This registered device is a mobile phone, or a registered system for receiving notifications. These notifications may include information about why the notification is being sent. This may include the vehicles speed or that a mobile device has been removed for a specified amount of time.

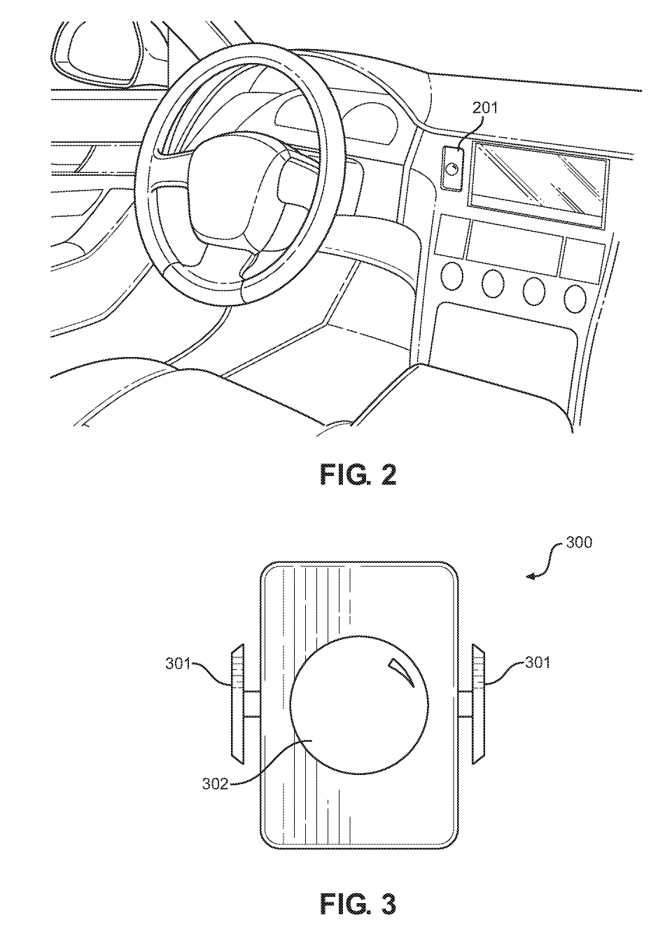

Referring now to FIGS. 2 and 3, there are shown various views of an embodiment of a mobile device receiver. In one embodiment, a mobile device receiver 201 is integrally placed within a dash of a vehicle. In this embodiment, the phone is placed within the mobile device receiver 201. In this embodiment, a sensor is used to determine if the mobile device is present. In another embodiment, the mobile device is connected to the mobile device receiver 201. This is done via a cord or other type of connection.

In a different embodiment of the mobile device receiver, the receiver is an add on receiver 300. This receiver 300 is capable of attaching to various locations within the vehicle. The add on receiver 300 may have a sensor 302 to register that the mobile device is present. Further, the device is held in place via clips 301. These clips can extend and retract to accommodate numerous types of mobile devices.

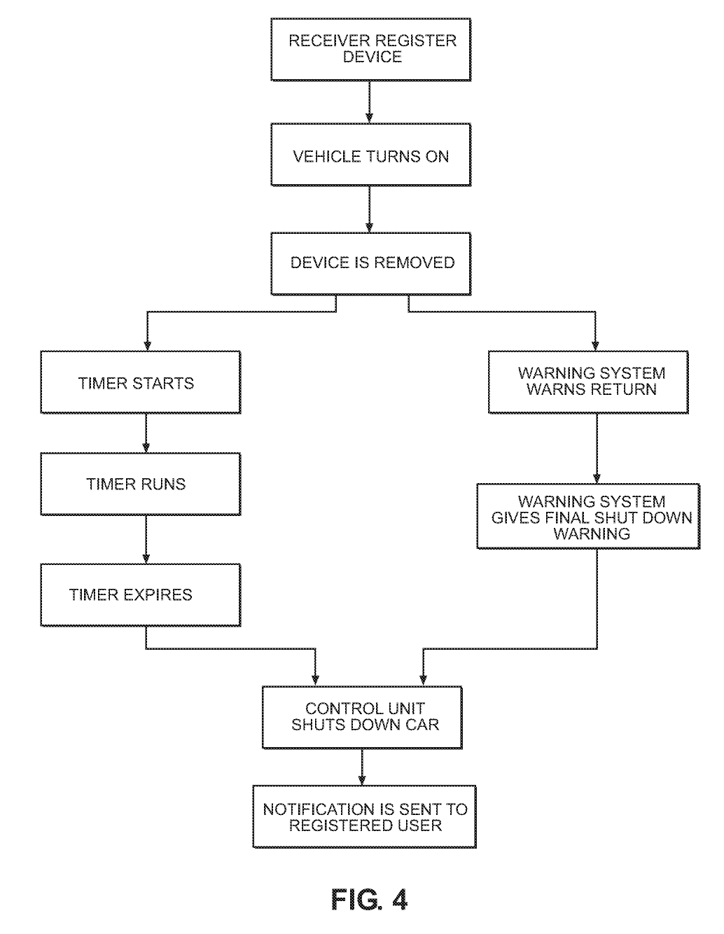

Referring now to FIG. 4 there is shown a flow chart of an embodiment of a method of using the safety system to improve the safety of vehicle operation by preventing cell phone usage while driving. The system starts monitoring when a mobile device is placed in the device receiver. The receiver registers that a device has been placed thereon. The vehicle is then started and driving then commences. If the device is removed from the receiver, the receiver communicates with the control unit and the timer is started. At the same time, a warning is sounded to instruct the driver to return the mobile device to the receiver. After the timer expires, a final warning is given. After this final warning, the control unit communicates with the ignition system and shuts the vehicle down. This shut down may only occur is the vehicle is traveling less than 50 miles per hour. This is to ensure safety of the driver. The driver will still have control of the vehicle in this instance until the vehicle is at a full stop. At which time the vehicle will need to be restarted.

After vehicle shutdown a notification is sent to a registered user that a mobile device was removed from the device for an extended period of time and that a shutdown occurred. In an alternative embodiment the mobile device receiver can be switched with a speed threshold registered by the speedometer. In an alternative embodiment a notification may be sent as soon as the device is removed. This will ensure a parent is warned anytime a teen uses a mobile device while driving.

In one embodiment the control unit slows the vehicle down if a speed limit is surpassed. In one example if the speed limit is 55 mile per hour a driver may be traveling at 70 miles per hour. In this example the control unit would be capable of slowing the vehicle down to the 55 mile an hour mark. In another example the control unit would only slow the vehicle down if the driver was traveling at more than 5 miles per hour over the speed limit. In another embodiment the control unit can determine the flow rate of traffic and only slow the vehicle down if the flow rate speed is surpassed.

It is therefore submitted that the instant invention has been shown and described in what is considered to be the most practical and preferred embodiments. It is recognized, however, that departures is made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents is resorted to, falling within the scope of the invention.

I claim:

1) A vehicle safety system, comprising:
a control unit operably coupled to a vehicle;
a mobile device receiver operably coupled to the control unit, wherein the mobile device receiver is configured to register when a mobile device is coupled thereto;
wherein the control unit is configured to deactivate the vehicle if the mobile device is removed from the mobile device receiver.

2) The vehicle safety system of claim 1, further comprising a speed sensor operably coupled to the control unit.

3) The vehicle safety system of claim 1, wherein the control unit is coupled to an ignition system of the vehicle.

4) The vehicle safety system of claim 1, wherein the control unit is configured to deactivate the vehicle after issuing a warning to a driver.

5) The vehicle safety system of claim 1, wherein the control unit is configured to deactivate the vehicle after a predetermined amount of time.

6) The vehicle safety system of claim 2, wherein the control unit is configured to deactivate the vehicle after a predetermined speed is exceeded.

7) The vehicle safety system of claim 1, further comprising a notification unit operably coupled to the control unit.

8) The vehicle safety system of claim 7, wherein the notification unit is configured to send a notification when the mobile device is removed from the mobile device receiver.

9) The vehicle safety system of claim 7, wherein the notification unit is configured to send a notification when a predetermined speed is exceeded.
